(19) United States
(12) Patent Application Publication
(10) Pub. No.: US 2019/0322450 A1
(43) Pub. Date: Oct. 24, 2019

(54) DISPOSAL BIN APPARATUS AND METHOD

(71) Applicant: Walmart Apollo, LLC, Bentonville, AR (US)

(72) Inventors: John J. O'Brien, Farmington, AR (US); Robert L. Cantrell, Herndon, VA (US)

(21) Appl. No.: 16/380,789

(22) Filed: Apr. 10, 2019

Related U.S. Application Data
(60) Provisional application No. 62/660,435, filed on Apr. 20, 2018.

(51) Int. Cl. B65F 1/14

(52) U.S. Cl. CPC B65F 1/1426; B65F 2210/1443; B65F 2001/1489

(57) ABSTRACT

A disposal bin includes at least one identifying sensor that captures and provides identifying information for items placed in the disposal bin as well as at least one state sensor to capture and provide state information (such as the weight of the item) for such items. A control circuit operably couples to these sensors and responds to placement of a consumable commodity container in the disposal bin by using the identifying information to identify the consumable commodity container. The control circuit then accesses a data store to obtain a fullness metric corresponding to the container (for example, a weight for the consumable commodity container when full). The control circuit then uses that fullness metric and the state information to determine a current fullness state of the container. The control circuit can then determine whether to automatically take a replacement order action based upon the current fullness state.

### CROSS-REFERENCE TO RELATED APPLICATION

This application claims the benefit of U.S. Provisional Application No. 62/660,435, filed Apr. 20, 2018, which is incorporated herein by reference in its entirety.

### TECHNICAL FIELD

These teachings relate generally to disposal bins.

### BACKGROUND

Some consumable items are completely consumed through usage. In many cases, however, something remains even when the consumable item itself is completely consumed. Packaging, whether natural or artificial, exemplifies that which can remain after consumption. Examples of artificial packaging include but are not limited to cardboard and plastic boxes, compressible tubes, so-called blister packs, and so forth. Non-artificial packaging can include but are not limited to vegetable and fruit materials such as peels, husks, and so forth.

In some cases a user may purposefully decide that they do not wish to completely consume a particular consumable item. Such a decision can be based, for example, upon spoilage, disfavor with the item, or a lack of any future need for the item.

Disposal bins are often employed to accommodate the foregoing circumstances. Generally speaking, disposal bins serve to receive and aggregate disposed-of items. In some cases the contents of the disposal bin are then treated as trash, either through a waste disposal collection service or by taking the contents of the disposal bin to a collection point such as a landfill. In other cases the contents of the disposal bin are slated for recycling.

### BRIEF DESCRIPTION OF THE DRAWINGS

Various needs are at least partially met through provision of the disposal bin apparatus and method described in the following detailed description, particularly when studied in conjunction with the drawings, wherein:

FIG. 1 comprises a bock diagram as configured in accordance with various embodiments of these teachings;

FIG. 2 comprises a block diagram as configured in accordance with various embodiments of these teachings; and

FIG. 3 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a disposal bin includes at least one identifying sensor that captures and provides identifying information for items placed in the disposal bin as well as at least one state sensor to capture and provide state information (such as, for example, the weight of the item) for such items. A control circuit operably couples to these sensors.

This control circuit responds to placement of a consumable commodity container in the disposal bin by using the identifying information from the identifying sensor to identify the consumable commodity container. The control circuit then accesses a data store that correlates information regarding consumable commodity containers with information specifying corresponding fullness metrics to obtain a fullness metric corresponding to the consumable commodity container (for example, a weight for the consumable commodity container when full). The control circuit then uses that fullness metric and the aforementioned state information to determine a current fullness state of the consumable commodity container (by, for example, determining if the disposed-of container is full, nearly full, half full, or nearly empty).

The control circuit can then be configured to determine whether to automatically take a replacement order action for the consumable commodity container based, at least in part, upon the aforementioned current fullness state of the disposed-of consumable commodity container. As one example in these regards, the control circuit can be configured to automatically place a replacement order when the disposed-of consumable commodity container is more than three-fourths empty. As another example in these regards, the control circuit can be configured to not automatically order a replacement when the current fullness state of the consumable commodity container indicates that the consumable commodity container is more than half full.

The replacement order action can comprise, as suggested above, an automatic reordering action. These teachings will accommodate other approaches in these regards, however. For example, by one approach an automatic reordering action can comprise automatically adding the commodity to a candidate shopping list for later perusal and consideration by the user.

These teachings are highly flexible in practice and will accommodate various modifications and/or supplemental functionality as desired. As one example in these regards, the control circuit can be configured to further base the replacement order action upon freshness information for the consumable commodity container. As another example, the control circuit can be configured to also take historical usage information into account when deciding upon a particular replacement order action. And as yet another example, the control circuit can be configured to further base that determination upon a historical record of power outages.

So configured, these teachings provide an essentially transparent background capability of maintaining, or helping to maintain, an appropriate on-hand supply of various consumable items.

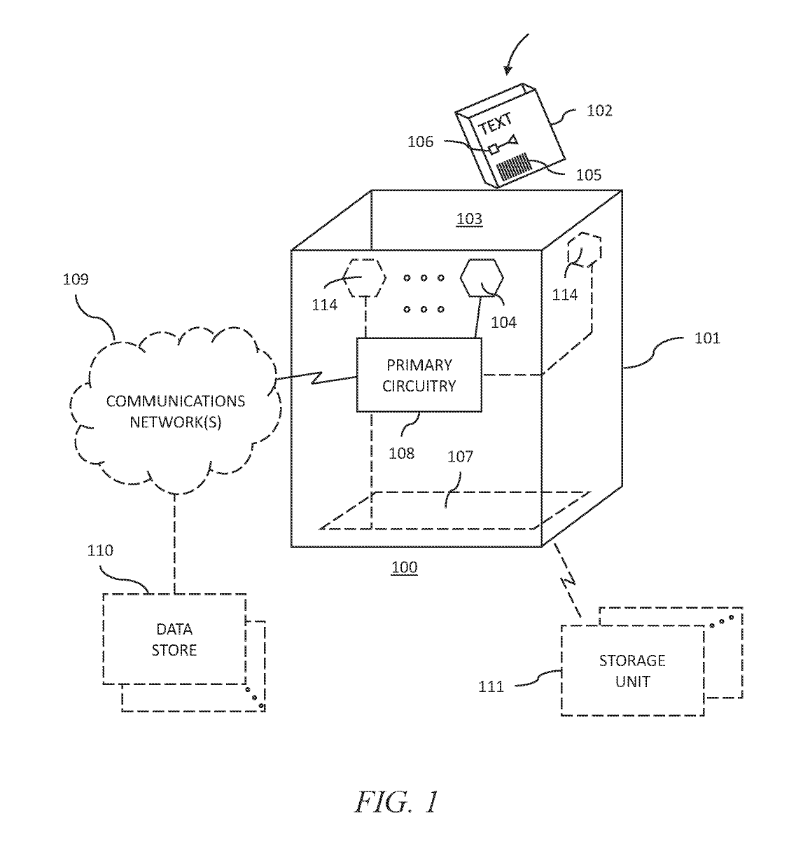

These and other benefits may become clearer upon making a thorough review and study of the following detailed description. Referring now to the drawings, and in particular to FIG. 1, an illustrative system 100 that is compatible with many of these teachings will now be presented.

This system 100 includes at least one disposal bin 101. Each such disposal bin 101 is configured to receive and aggregate items 102 that are being disposed of. Generally speaking, the disposal bin 101 comprises a container having a bottom and side walls that are disposed and attached to one another to form a void that can serve to receive and aggregate these disposed-of items 102. In a typical application setting the disposal bin 101 will have at least one opening 103 to receive the discarded items 102. This opening 103 can be formed at the top of the disposal bin 101 (as shown in FIG. 1) such that the items 102 are simply dropped down into the disposal bin 101. If desired, an opening (not shown) can be formed in one or more sides of the disposal bin 101 such that the items 102 are introduced horizontally into the disposal bin 101.

If desired, the disposal bin 101 can include a movable cover that partially or wholly selectively occludes part or all of the aforementioned opening 103. The disposal bin 101 illustrated in FIG. 1 lacks a cover for the sake of clarity and simplicity. The disposal bin 101 can be comprised of any suitable material including any of a variety of metals, plastics, composite materials, and natural materials such as wood or stone.

The disposal bin 101 can have any of a wide variety of sizes. For example, these teachings will accommodate relatively small disposal bins (such as an office wastebasket), a medium-sized disposal bin (such as a kitchen trash container), a larger-sized disposal bin (such as a household garbage can use for curbside trash pickup), and even very large disposal bins such as so-called dumpsters.

Generally speaking, these teachings can be compatibly applied with any of a wide variety of known disposal bins (including disposal bins designed and or intended for use in receiving items to be disposed of as well as items to be recycled). Because these teachings are not especially sensitive to any particular selections in these regards, further details and elaboration does not appear here for the sake of brevity.

In this illustrative system 100, the disposal bin 101 includes at least one identifying sensor 104 that is configured to capture and provide identifying information for an item 102 placed in the disposal bin 101. By one approach, at least one of these identifying sensors 104 comprises an optical code reader. This approach can be useful to read an optical code such as the ubiquitous Universal Product Code (UPC) 105 that can be found on many consumer products.

By another approach, in lieu of the foregoing or in combination therewith, at least one of these identifying sensors 104 comprises an image-capture component such as a still-image or video camera. One or more captured images of a disposed-of item 102 can serve to permit a visual identification of the item 102.

And by yet another approach, and again in lieu of the foregoing or in combination therewith, at least one of these identifying sensors 104 can comprise a wireless reader such as a radio-frequency identification (RFID) tag reader configured to read an RFID tag 106 that comprises a part of the disposed-of item 102. (Such an RFID tag 106 may comply and otherwise be compatible with, for example, the Electronic Product Code (EPC) Radio-Frequency Identity Protocols Class-1 Generation-2 Ultra-High Frequency (UHF) RFID Protocol for Communications at 860 MHz-960 MHz.)

In the illustrative example of FIG. 1, these identifying sensors 104 are all located proximal to the point of entry to the disposal bin 101. For example, some or all of these identifying sensors 104 can be located within 6 inches of the edge of the aforementioned opening 103. Such a location can help avoid or at least mitigate a situation where accumulated items 102 in the disposal bin 101 reach a point where they block the sensor's 104 view of newly-added items 102. If desired, different such sensors 104 can be disposed at different respective heights from one another.

These and other useful identifying sensors are known in the art. Because the present teachings are not overly sensitive to any particular selections in these regards, further elaboration regarding the details of such sensors is not provided here.

In this illustrative example the system 100 also includes at least one state sensor 107 that captures and provides state information for the item 102. In this illustrative example the sensed state comprises the weight of the discarded item 102 and the state sensor 107 comprises a weight sensor. So configured, the weight sensor can provide information regarding the weight of whatever contents were already in the disposal bin 101 before a particular item 102 is placed therein, and also information regarding the aggregated contents of the disposal bin 101 immediately following the particular item 102 being placed therein. Subtracting the former from the latter will yield the weight of the particular item 102 itself.

In this example the state sensor 107 is disposed at the bottom of the disposal bin 101. By one approach the state sensor 107 only weighs contents of the disposal bin 101. By another approach the state sensor weighs both the disposal bin 101 and the contents of the disposal bin 101.

In this illustrative example all of the foregoing sensors 104 and 107 operably couple to a primary circuitry module 108 and, in particular, to a control circuit that comprises a part of the primary circuitry module 108.

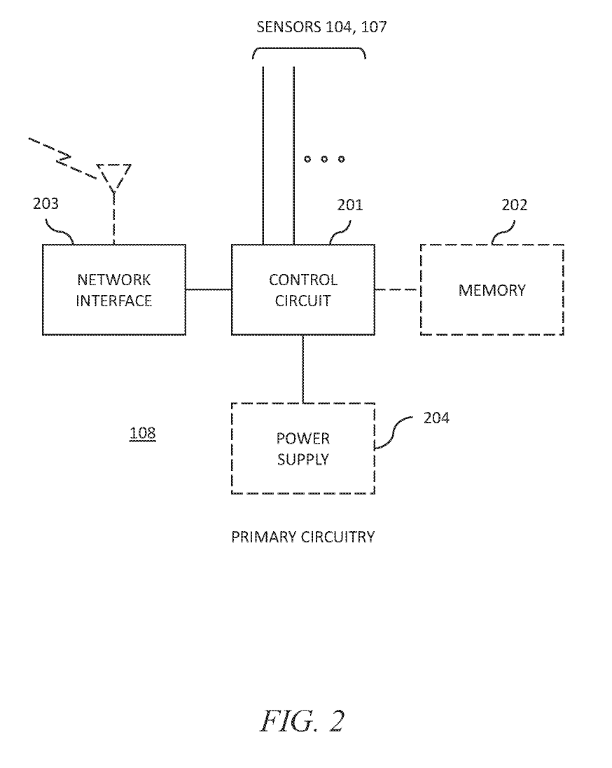

Referring momentarily to FIG. 2, and being a “circuit,” this control circuit 201 comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to a memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to other information described herein, this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 also operably couples to a network interface 203. So configured, and referring again to FIG. 1 as well, the control circuit 201 can operably couple to a communications network 109 to thereby communicate with other elements such as one or more data stores 110 that are physically remote from the control circuit 201 (for example, by being located many miles away from the control circuit 201). Such a data store 110 can serve, for example, to store and make available information regarding various metrics for various items 102 (such as but not limited to fullness metrics corresponding to items 102 that comprise consumable commodity containers such as the specific weights that correspond to full consumable commodity containers). Network interfaces, including both wireless and non-wireless platforms, are well understood in the art and require no particular elaboration here.

Referring again to FIG. 2, the control circuit 201 can operably couple to a power supply 204. This power supply 204 can comprise a standalone power supply such as one or more batteries. In lieu of the foregoing or in combination therewith, the power supply 204 can directly connect to a power mains such as a 120 V 60 cycle alternating current source. Power supplies of various kinds are very well understood in the art and do not require further description here. When the power supply 204 connects to a household alternating current supply, the control circuit 201 can be optionally configured to detect power outages and can further maintain a historical record of when such outages occur and their respective durations. Such information can be utilized as described further herein.

Referring again to FIG. 1, by one optional approach the aforementioned control circuit 201 can also communicate (via, for example, the aforementioned network interface 203) with one or more other storage units 111 (or with other components configured to monitor such storage units 111).

For example, one such storage unit 111 may comprise a kitchen refrigerator that is configured with one or more sensors to provide identifying information regarding contents of the refrigerator and/or freshness information regarding such contents. So configured, the sensor, such as a freshness information sensor, comprises part of the refrigerator. Such a sensor may comprise, for example, an image capture component configured to capture images of a freshness code printed or otherwise visually present on an exterior surface of monitored items.

As another example, one such storage unit 111 may comprise a kitchen cupboard or pantry having one or more sensors configured to provide identifying information regarding contents of the storage unit and/or freshness information regarding such contents. Such information, when available, can be utilized by the control circuit 201 as described further herein.

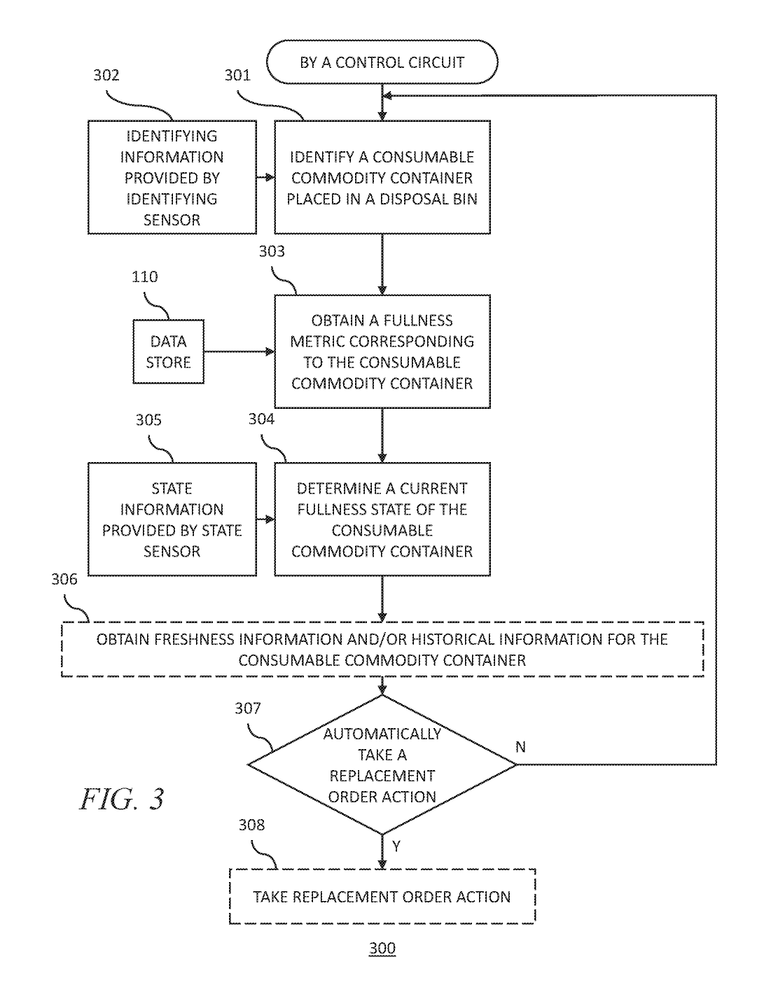

FIG. 3 presents a process 300 that can be carried out by the control circuit 201 in conjunction with the above-described system 100. This process 300 can be triggered by, for example, an item 102 comprising a consumable commodity container being placed in the disposal bin 101.

As used herein, the word “consumable” refers to a product that can be at least partially used up or otherwise depleted during use. As one example, food and drink are consumable in that these items are ingested by the user. As another example, other items, such as various health and beauty products (such as toothpaste, cosmetics, mouthwash, and so forth), are used up over time through application on a given surface.

As used herein, the word “container” refers to so-called user packaging (as versus, for example, cartons, pallets, and so forth that are primarily used only to ship products, often in bulk, from a place of manufacture or importation to a distribution center or retail sales facility. Examples of containers include cardboard and plastic boxes and cartons, deformable tubes, pouches and bags, and so forth (that typically include consumer information printed or otherwise disposed thereon including branding, ingredients, usage instructions, cautions, and so forth). As a simple illustrative example, then, toothpaste is a consumable commodity and the deformable plastic tube that contains the toothpaste constitutes the corresponding consumable commodity container.

At block 301 the control circuit 201 responds to placement of the consumable commodity container in the disposal bin 101 by using identifying information 302 provided by one or more of the above-described identifying sensors 104 to identify, at block 301, the consumable commodity container. When the disposed-of item 102 includes an optical code such as a UPC code, the identifying information 302 can comprise the corresponding code (i.e., the Stock Keeping Unit (SKU) code conveyed by the UPC code. In such a case the control circuit 201 can utilize that SKU code to identify the product by brand (along with other useful metadata such as a weight or volume size indicator).

At block 303 the control circuit 201 accesses the aforementioned data store 110 to obtain a fullness metric corresponding to the identified consumable commodity container. This can comprise, for example, using the above-described identifying information 302 to appropriately access the data store 110 in order to extract the appropriate corresponding information. By one approach, this fullness metric includes information specifying a weight of the consumable commodity container corresponding to a full consumer commodity container (i.e., the weight of the product as shipped by the manufacturer and prior to usage by the consumer).

At block 304 the control circuit 201 obtains state information 305 provided by the above-described state sensor 107 and uses that information in conjunction with the fullness metric corresponding to the consumable commodity container to determine a current fullness state of the consumable commodity container. As noted above, the state information 305 can comprise a present weight of the aggregated contents of the disposal bin 101. By subtracting the just-previous weight of those contents (i.e., just prior to the present consumable commodity container being placed in the disposal bin 101) from the current weight of those contents, the control circuit 201 can calculate a present weight of that consumable commodity container (which weight will reflect both the weight of the container itself and any unused portion of the consumable commodity itself still contained therein). This resultant calculated weight reflects a current fullness state of the consumable commodity container.

If desired, the control circuit 201 can also take into account the weight of the consumable commodity container itself in the absence of any consumable commodity whatsoever (i.e., the truly empty weight of the container). Such a metric could be obtained, for example, from the aforementioned data store 110. By using this metric, the control circuit 201 can subtract the empty weight of the container itself from the aforementioned calculated result to determine a weight of any residual consumable commodity still retained within the consumable commodity retainer.

Knowing the original weight of the consumable commodity container when full, and now knowing the current weight, the control circuit 201 can determine the current fullness state of the container. The current fullness state can be represented as a substantially accurate fractional value or decimal value, or can be more generally represented by an approximate characterization (such as “half full,” “nearly empty,” and so forth) as desired.

If desired, and as illustrated at optional block 306, the control circuit 201 can also take into account other kinds of information in this process 300. For example, in addition to the calculated fullness state of the consumable commodity container, the control circuit 201 can also take into account freshness information for the consumable commodity container. In these regards, and as noted above, the control circuit 201 may be in communication with one or more other storage units 111 that include a freshness information sensor configured to determine freshness of the consumable commodity container. Such a freshness sensor may comprise, for example, an image capture mechanism that captures images of a freshness code on the packaging of the item. As another example, the storage unit 111 may be configured to detect initial placement of an item therein such that the control circuit 201 can be provided with information regarding how long it has been since that item was first placed in that storage unit 111.

As another example, in addition to the calculated fullness state of the consumable commodity container the control circuit 201 can make use of historical information pertaining to the consumable commodity container by further basing the aforementioned determination upon such historical information. This historical information can comprise, for example, historical usage information corresponding to this particular consumable commodity (i.e., how often in the past this household has utilized this particular consumable commodity, a rate at which the household has previously utilized this particular consumable commodity, and so forth). Such information may be developed and retained by the control circuit 201 itself or may be obtained from other sources such as but not limited to the aforementioned storage unit 111 and/or data store 110. As another example of historical information, the control circuit 201 may take into account a historical record of power outages at this location (in particular, power outages that may have shortened the shelf life of a perishable consumable commodity).

At block 307 the control circuit 201 determines whether to automatically take a replacement order action for the consumable commodity container based, at least in part, upon the current fullness state of the consumable commodity container (as well as, if desired, the aforementioned freshness information and/or historical information). These teachings will accommodate a variety of different replacement order actions. Examples include but are not limited to automatically placing an order to have a replacement delivered for the corresponding commodity, automatically placing an order for a differently-sized consumable commodity container (such as a larger-sized or smaller-sized) consumable commodity container to replace the consumable commodity container, automatically adding the commodity to a shopping list for the corresponding consumer (for example, by interfacing with the user's smart phone to add the commodity to a shopping list that the user maintains on that smart phone), and so forth.

As a simple illustrative example in these regards, the control circuit 201 can accordingly determine whether to automatically take a replacement order action for the consumable commodity container based, at least in part, upon the current fullness state of the consumable commodity container by determining not to automatically order a replacement when the current fullness state of the consumable commodity container indicates that the consumable commodity container is more than half full. In this case, it may be presumed that the user is not satisfied with the consumable commodity and hence is throwing the consumable commodity away even though a considerable amount of the commodity remains unused.

As a further example in these same regards, however, if the control circuit 201 also has freshness information for the commodity and can determine that it is likely that the item has been thrown away due to a lack of freshness, the control circuit 201 may decide upon a replacement order action comprising automatically ordering a replacement for the consumer commodity container, albeit of a smaller size that is more suited to the user's apparent rate of usage.

At optional block 308, the control circuit 201 can effect the decided-upon replacement order action as appropriate.

So configured such a system 100 can help to ensure orderly and timely replacement of consumable items in a transparent or largely transparent manner that requires little or no training for the user. If desired, these teachings can be employed in combination with other methodologies and systems to further refine re-ordering approaches as desired.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system comprising:
a disposal bin configured to receive and aggregate items to be disposed of, the disposal bin including at least one identifying sensor to capture and provide identifying information for an item placed in the disposal bin and at least one state sensor to capture and provide state information for the item; and
a control circuit that is:
operably coupled to the at least one identifying sensor and to the at least one state sensor;
operably coupled to a data store that correlates information regarding consumable commodity containers with information specifying corresponding fullness metrics; and
operably coupled to a communications network;
wherein the control circuit is configured to respond to placement of a consumable commodity container in the disposal bin by:
using identifying information provided by the at least one identifying sensor to identify the consumable commodity container;
accessing the data store to obtain a fullness metric corresponding to the consumable commodity container;
using the fullness metric corresponding to the consumable commodity container and the state information for the consumable commodity container provided by the at least one state sensor to determine a current fullness state of the consumable commodity container;
determining whether to automatically take a replacement order action for the consumable commodity container based, at least in part, upon the current fullness state of the consumable commodity container.

2. The system of claim 1 wherein the at least one identifying sensor comprises an optical code reader.

3. The system of claim 1 wherein the at least one identifying sensor comprises an image-capture component.

4. The system of claim 1 wherein the at least one state sensor comprises a weight sensor.

5. The system of claim 1 wherein the data store is physically remote from the control circuit and wherein the control circuit accesses the data store via the communications network.

6. The system of claim 1 wherein the information specifying corresponding fullness metrics comprises information specifying weights corresponding to full consumable commodity containers.

7. The system of claim 1 wherein the control circuit is configured to determine whether to automatically take a replacement order action for the consumable commodity container based, at least in part, upon the current fullness state of the consumable commodity container by determining not to automatically order the replacement when the current fullness state of the consumable commodity container indicates that the consumable commodity container is more than half full.

8. The system of claim 1 wherein the control circuit is further configured to determine whether to automatically take a replacement order action for the consumable commodity container based, at least in part, upon the current fullness state of the consumable commodity container by determining whether to automatically order a replacement for the consumable commodity container based, at least in part, upon both the current fullness state of the consumable commodity container and freshness information for the consumable commodity container.

9. The system of claim 8 wherein the control circuit operably couples to at least one freshness information sensor configured to determine freshness of the consumable commodity container.

10. The system of claim 9 wherein the at least one freshness information sensor comprises an image capture component.

11. The system of claim 9 wherein the at least one freshness information sensor comprises part of a refrigerator.

12. The system of claim 1 wherein the control circuit is configured to determine whether to automatically take a replacement order action for the consumable commodity container based, at least in part, upon the current fullness state of the consumable commodity container by further determining whether to automatically order a differently-sized consumable commodity container to replace the consumable commodity container.

13. The system of claim 12 wherein the control circuit is configured to determine whether to automatically order a differently-sized consumable commodity container to replace the consumable commodity container by further taking into account historical usage information corresponding to the consumable commodity container.

14. The system of claim 1 wherein the control circuit is configured to determine whether to automatically take a replacement order action for the consumable commodity container based, at least in part, upon the current fullness state of the consumable commodity container by further basing the determination upon a historical record of power outages.

15. A method comprising:
by a control circuit that is operably coupled to:
at least one identifying sensor that captures and provides identifying information for an item placed in a disposal bin;
at least one state sensor that captures and provides state information for the item;
a data store that correlates information regarding consumable commodity containers with information specifying corresponding fullness metrics; and
a communications network:
using identifying information provided by the at least one identifying sensor to identify a consumable commodity container placed in the disposal bin;
accessing the data store to obtain a fullness metric corresponding to the consumable commodity container;
using the fullness metric corresponding to the consumable commodity container and the state information for the consumable commodity container provided by the at least one state sensor to determine a current fullness state of the consumable commodity container;
determining whether to automatically take a replacement order action for the consumable commodity container based, at least in part, upon the current fullness state of the consumable commodity container.

16. The method of claim 15 wherein the at least one identifying sensor comprises at least one of:
an optical code reader; and
an image-capture component;
and the at least one state sensor comprises a weight sensor.

17. The method of claim 16 wherein the information specifying corresponding fullness metrics comprises information specifying weights corresponding to full consumable commodity containers.

18. The method of claim 17 wherein determining whether to automatically take a replacement order action for the consumable commodity container is further based upon freshness information for the consumable commodity container.

19. The method of claim 18 wherein determining whether to automatically take a replacement order action for the consumable commodity container is further based upon historical usage information corresponding to the consumable commodity container.

20. The method of claim 19 wherein determining whether to automatically take a replacement order action for the consumable commodity container is further based upon a historical record of power outages.
